(19) United States
(12) Patent Application Publication
(10) Pub. No.: US 2022/0149605 A1
(43) Pub. Date: May 12, 2022

(54) DOUBLE-SIDED OPEN-TYPE CONDUIT BOX FOR WIRING ELECTRIC WIRES

(71) Applicant: HANYANG OCS CO., LTD., Incheon (KR)

(72) Inventor: Cheon Sik OH, Incheon (KR)

(21) Appl. No.: 17/438,890

(22) PCT Filed: Jul. 24, 2019
(86) PCT No.: PCT/KR2019/009149

§ 371 Date: Sep. 13, 2021

(30) Foreign Application Priority Data
Mar. 11, 2019 (KR) 10-2019-0027535

(51) Int. Cl. H02G 3/08; F16B 7/14

(52) U.S. Cl. CPC H02G 3/083; F16B 7/1418

(57) ABSTRACT

Present invention relates to a double-sided open-type conduit box for wiring electric wires, capable of facilitating wiring work by a simple structure and simultaneously providing convenience in manufacturing and assembling the box. According to the present invention, provided is a double-sided open-type conduit box for wiring electric wires, comprising: a box body in which inlet and an outlet, rough which a cable goes in and out, are formed at both sides of an inner space of a predetermined size, and wherein first and second openings are formed to open one side and the other side of the inner space; first and second covers configured to open and close the openings respectively; and guide wheels mounted in the inner space and rolled to guide the progress of the cable; and wheel coupling portions formed to mount the guide wheels.

### CROSS-REFERENCE TO RELATED APPLICATIONS

This application is a national stage application of PCT/KR2019/009149 filed on Jul. 24, 2019, which claims priority of Korean patent application number 10-2019-0027535 filed on Mar. 11, 2019. The disclosure of each of the foregoing applications is incorporated herein by reference in its entirety.

### TECHNICAL FIELD

The present invention relates to a double-sided open-type conduit box for wire wiring, and more particularly, to a double-sided open-type conduit box for wire wiring that is provided for easy wiring by a simple structure and can provide convenience in manufacturing and assembling the box.

### RELATED ART

In general, a conduit box for wiring electric wires is installed so that it can be attached or buried on a wall or ceiling slab during the construction of a building to change the wiring direction of the electrical wire to a desired direction or to take out the electrical wire to the indoor side at an appropriate location. An example will be described with reference to the illustrated drawings.

As shown in FIG. 1, the conventional conduit box 10 is provided with a box body 11 having an inner space 12 of a certain size and a cover 13 coupled to the box body 11, the box body 11 is formed with an inlet 14 and an outlet 15 through which the cable C enters and exits on both sides, and an opening 16 through which the cover 13 can be opened and closed is formed on one surface.

In addition, guide wheels 20 are installed on the inner space 12 adjacent to the inlet 14 and the outlet 15. The guide wheels 20 are provided so as to roll while the cable C is in contact during the wiring process. Accordingly, the operation of pushing in or pulling out the cable C can be performed smoothly.

In order to install the guide wheel 20 on the box body 11, first and second shaft projections 17 and 18 protruding into the inner space are formed on the upper and lower portions of the box body 11. The guide wheel 20 is manufactured in the form of a roller unit in which a plurality of rollers 22 is combined on a wheel shaft 21. In order to mount the guide wheel 20 on each of the shaft projections 17 and 18, on which coupling holes 19 are formed by a separate machining operation.

Since, the conventional box body 11 is provided to open and close only the upper surface by the cover 13 in a state where the lower surface is blocked, in order to form the coupling holes 19 on the shaft projections 17 and 18, in the state in which the cover 13 is opened, the first shaft projection 17 must be penetrated by a cutting tool to form hole in the second shaft projection 18 of the lower portion of the box body 11, so that the two shaft projections 17 and 18 can be successively drilled or tapped. In general, the cutting edge portion of the cutting tool is relatively short compared to the standard height of the box body 11. Therefore, in the process of machining the second shaft projection 18 located in the lower portion of the box body 11 by the cutting edge, the body portion of the cutting tool interferes with the first shaft projection 17. Accordingly, there is a high possibility that the body portion of the cutting tool having a relatively large diameter is inserted into the hole machined by the first shaft protrusion 17, thereby causing a machining defect due to damage to the machining hole.

In addition, in forming the coupling holes 19 on each of the shaft projections 17 and 18, since the first shaft projection 17 and the second shaft projection 18 are vertically spaced apart, the cutting tool after passing through the first shaft projection 17, it proceeds in an idle state and enters on the second shaft projection 18. As a result, there is a risk that the tool may be damaged while the cutting tool penetrates the discontinuous objects. In addition, due to the manufacturing characteristics of the box body 11, which is typically manufactured by casting, the dimensional precision of the first shaft projection 17 and the second shaft projection 18 may decrease, which may cause processing difficulties.

### DETAILED DESCRIPTION OF THE INVENTION

### Technical Problem to be Solved

The present invention is to solve the problems described above. The present invention is to provide a double-sided open-type conduit box for wiring electric wires that can provide the convenience of processing work, by the body structure with both sides open, and that can provide the convenience of manufacturing the box itself or assembling components.

### Technical Solution of the Invention

According to an one feature of the present invention, provided is a double-sided open-type conduit box for wiring electric wires, comprising: a box body 31 in which an inlet 33 and an outlet 34, through which a cable C goes in and out, are formed at both sides of an inner space 32 of a predetermined size, and first and second openings 35 and 36 are formed to open one side and the other side of the inner space 32; first and second covers 37 and 38 which are configured to open and close the openings 35 and 36, respectively; and guide wheels 60 mounted in the inner space 32 and rolled to guide the progress of the cable C; and wheel coupling portions 39 formed to mount the guide wheel 60.

According to another feature of the present invention, provided is a double-sided open-type conduit box for wiring electric wires, wherein the wheel coupling portions 39 are formed to protrude into the inner space 32 on the box body 31, comprising first coupling protrusions 41 formed on the side of the first opening 35 and second coupling protrusions 41 formed on the side of the second opening 36 to correspond to the first coupling protrusion 40.

According to another feature of the present invention, provided is a double-sided open-type conduit box for wiring electric wires, wherein the wheel coupling portion. 39 includes a coupling protrusion 44 formed on the side of the first opening 35 to protrude into the inner space 32 on the box body 31, and a coupling groove 45 formed on the surface of the second cover 38 to correspond to the coupling protrusion 44.

According to another feature of the present invention, provided is a double-sided open-type conduit box for wiring electric wires, wherein a guide wheel 60 includes a wheel shaft 61 extending to a predetermined length and rollers 62 rotatably coupled to the wheel shaft 61, and wherein, shaft holes 43 to which the ends of the wheel shafts 61 are coupled are formed in each coupling protrusion 40, 41 or 44 of the wheel coupling portions 39.

According to another feature of the present invention, provided is a double-sided open-type conduit box for wiring electric wires, wherein the guide wheel 60 includes a wheel shaft 61 extending to a predetermined length, rollers 62 rotatably coupled to the wheel shaft 61, and a plate-shaped coupling piece 63 extending to one side of the rollers 62 connected to the wheel shaft 61, and wherein in each coupling protrusion 40, 41 and 44 of the wheel coupling portions 39, cut-out grooves 42 and 46 into which the coupling piece 63 is inserted are formed.

According to another feature of the present invention, provided is a double-sided open-type conduit box for wiring electric wires, wherein the box body 31 is integrally formed with connector parts 47 and 48 to extend the inlet 33 and the outlet 34, and wherein fastening holes 49 of a certain size is formed on one side of the outer periphery on each of the connector parts 47 and 48, and the tube bodies P1 and P2 connected to the box body 31 are fastened by tightening bolts 50.

According to another feature of the present invention, provided is a double-sided open-type conduit box for wiring electric wires, wherein the box body 31 has a curved portion 51 of a certain curvature extending from the inlet 33 to the outlet 34 on the inner space 32, or the shape of the box body 31 itself is in the form of an elbow.

### Effects of the Invention

As described above, according to the present invention, there is an advantage of providing convenience in manufacturing, such as it is provided to detachably couple the covers 37 and 38 to both sides of the box body 31. During the manufacturing process, when the molded product is removed from the mold, there is no jamming due to the internal structure. In addition, the box body 31 manufactured by die casting or the like can be easily withdrawn from the mold.

In addition, the box body 31 of the bidirectional open structure of the present invention has the advantage of increasing convenience in manufacturing, such as in the process of forming the shaft holes 43 with a cutting tool in order to mount the guide wheel 60 on the inner space 32, it is possible to separately process the front and rear surfaces of the box body 31.

In addition, the present invention has the advantage of providing convenience in the coupling operation, such as by forming the wheel coupling part 39 on the box body 31 and the second cover 38 located on the rear surface, the guide wheel 60 can be coupled in various ways such as shaft coupling or fitting coupling.

In addition, the present invention has the advantage that the tube bodies P1 and P2 connected on the box body 31 can be conveniently combined even in a state without a separate connector interposed therebetween, such as the connector parts 47 and 48 extending the inlet 33 and the outlet 34 are integrally formed on the box body 31, and the tightening bolts 50 are directly mounted on the connector parts 47 and 48.

In addition, the present invention has the advantage of providing convenience in wiring work, such as by forming a curved portion 51 of a certain curvature in the box body 31 or formed in an elbow shape, so that it is easily possible when the cable C is pushed into the box body 31.

### BRIEF DESCRIPTION OF THE DRAWINGS

FIG. 1 is a cross-sectional view showing an example of the prior art;

FIG. 2 is a perspective view according to an embodiment of the present invention;

FIG. 3 is an exploded perspective view according to an embodiment of the present invention;

FIG. 4 is a plan cross-sectional view according to an embodiment of the present invention;

FIG. 5 is a front cross-sectional view according to an embodiment of the present invention;

FIG. 6 is an exploded perspective view showing another embodiment of the present invention;

FIG. 7 is an exploded perspective view showing another embodiment of the present invention;

FIG. 8 is a front cross-sectional view according to the embodiment of FIG. 7;

FIGS. 9A and 9B are plan views showing another embodiment of the present invention;

FIGS. 10A and 10B are plan views showing another embodiment of the present invention;

FIGS. 11A and 11B are plan views showing another embodiment of the present invention; and

FIG. 12 is a plan view showing another embodiment of the present invention.

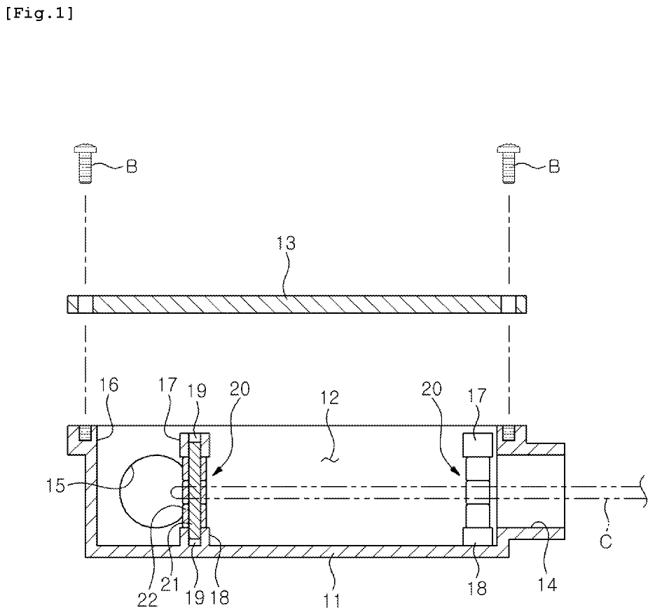

### DETAILED DESCRIPTION OF THE INVENTION

The objects, features and advantages of the present invention described above will become more apparent through the following detailed description. Hereinafter, preferred embodiments of the present invention will be described based on the accompanying drawings.

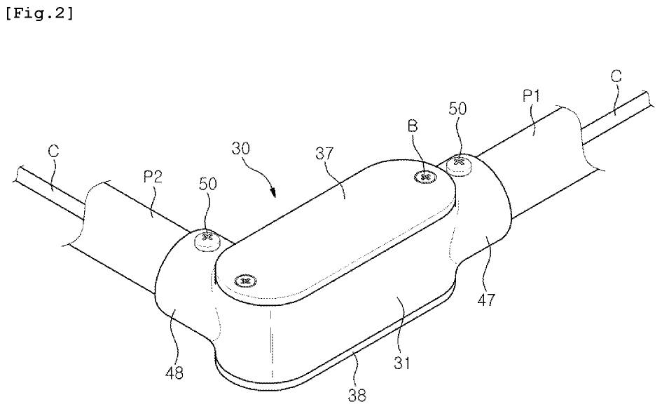

FIGS. 2 to 12 show various embodiments of the present invention. As shown in FIG. 2, the conduit box 30 of the present invention has a box body 31 of a certain size, and a first cover 37 and a second cover 38 are combined on both sides of the box body 31. On both sides of the piping box, the protruding connector parts 47 and 48 for connecting the first pipe body P1 and the second pipe body P2 are integrally formed. Tightening bolts 50 for fixing the respective tubular bodies P1 and P2 are fastened on the connector parts 47 and 48.

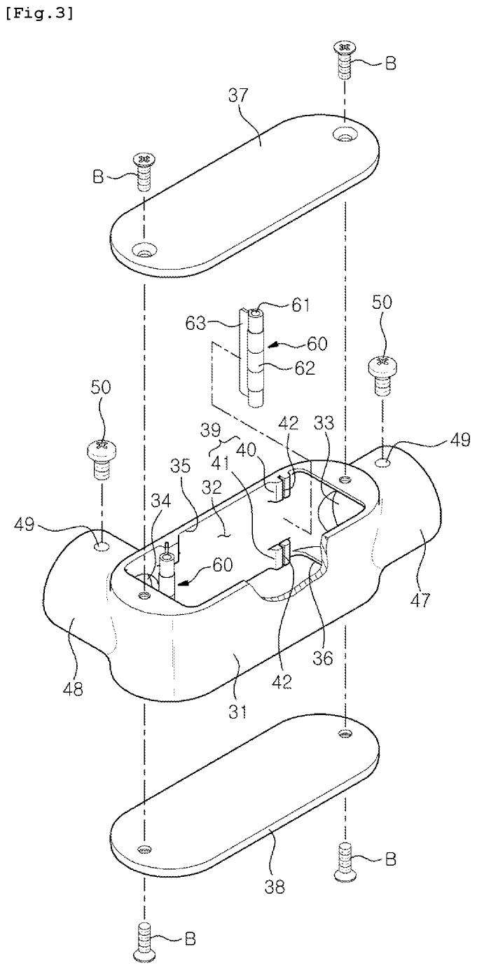

This conduit box 30 is positioned between the pipes, conduits or tubes P1 and P2 extending to a certain length, so that the cable C such as electric wires passes through. The box body 31 of the present invention has a structure in which both sides are open. Accordingly, it is possible to manufacture by various methods, regardless of the molding method such as casting or die casting. The detailed configuration and operating state of the present invention will be described with reference to FIGS. 3 to 5 as follows.

As shown in FIG. 3, the box body 31 of the present invention has an inner space 32 having a predetermined size therein. An inlet 33 and an outlet 34 are formed on both sides of the inner space 32. And it is extended to a predetermined length by the connector parts 47 and 48. Fastening holes 49 for fastening the fastening bolts 50 as described above is formed on one side of the outer periphery of the connector parts 47 and 48.

In addition, a first opening 35 for opening one surface of the inner space 32 is formed in the box body 31 of the present invention. In addition, a second opening 36 facing the first opening 35 to open the other surface of the inner space 32 is formed. The first cover 37 and the second cover 38 are detachably coupled by bolts B or the like to open and close the first opening 35 and the second opening 36.

The box body 31 is provided with guide wheels 60 positioned on the periphery of the inlet 33 and the outlet 34 on the inner space 32 to guide the cable C. In order to mount the guide wheels 60, wheel coupling portions 39 protruding into the inner space 32 are formed on the inner wall surface of the box body 31.

The wheel coupling portion 39 includes a first coupling protrusion 40 positioned at the side of the first opening 35 and a second coupling protrusion 41 positioned at the side of the second opening 36 to correspond to the first coupling protrusion 40. A cut-out groove 42 with an open side surface is formed on each of these coupling protrusions 40 and 41 to fit the guide wheel 60 thereinto.

In this case, the guide wheel 60 is rotatably coupled to rollers 62 on the wheel shaft 61 having a predetermined length. A plate-shaped coupling piece 63 extending to one side of the rollers 62 connected to the wheel shaft 61 may be provided. The guide wheel 60 may be fixedly installed in a state in which the coupling piece 63 is fitted on the cut-out groove 42.

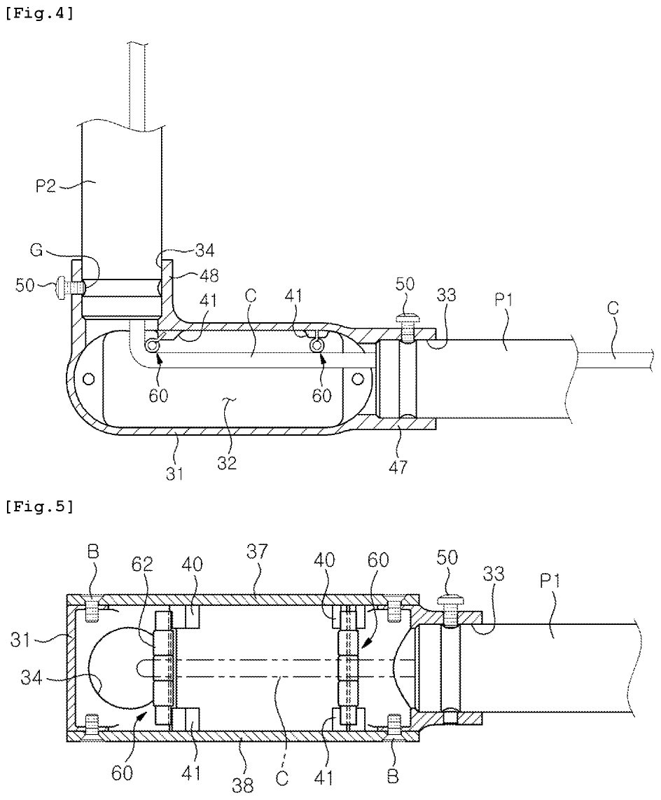

As shown in FIG. 4, the conduit box 30 of the present invention is installed in a state in which the pipes P1 and P2 are connected to a wall or a ceiling slab during construction of a building, thereby allowing the cable to pass therein. In this case, on the back side of the box body 31 in contact with the installation surface of the installation place, the first cover 37 located on the front side is opened while the second cover 38 is covered, and the cable C is delivered manually.

Here, during the wiring work of manually moving the cable C, the cable C is in contact with the guide wheels 60. Therefore, it is possible to smoothly pull the cable, etc., and also it is possible to prevent damage to the covering of the cable C.

As shown in FIG. 5, after the wiring work is completed, the first cover 37 is coupled to the box body 31. Accordingly, the inner space 23 of the box body 31 through which the cable C passes is sealed. Then, by opening the first cover 37, it is possible to perform maintenance work, such as replacement or inspection of the cable C.

On the other hand, in the box body 31 of the present invention, the connector parts 47 and 48 extending the inlet 33 and the outlet 34 are integrally formed. Fastening the tightening bolts 50 to the fastening holes 49 in a state where the ends of the first tube body P1 and the second tube body P2 are inserted on the connector parts 47 and 48, and each of the tube bodies P1 and P2 is pressed and fixed on the outer periphery. This connector-integrated box body 31 does not require a separate connector to connect each tube body P1 or P2. In addition, there is no need to form a thread at the end of the box body 31 or the tube bodies P1 and P2. Therefore, it is possible to provide convenience in manufacturing and assembly operations. A press-in groove G into which the end of the tightening bolt 50 is inserted is formed on each of the tubular bodies P1 and P2, so that the coupling state can be firmly maintained.

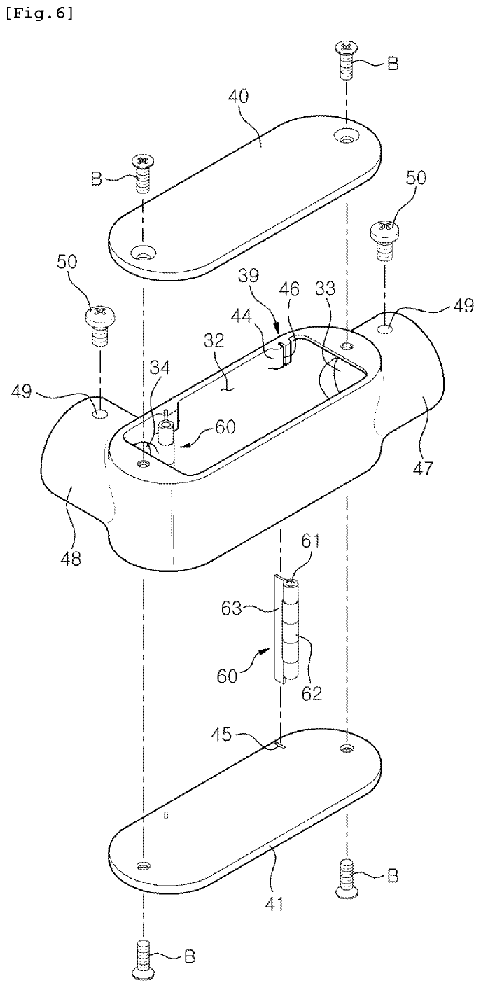

In the above-described example, it has been described that the guide wheels 60 are fitted on the box body 31. Other coupling methods other than those described with reference to FIGS. 6 to 8 are as follows.

As shown in FIG. 6, another configuration of the present invention is an example configured to couple the guide wheels 60 using both the box body 31 and the second cover 38 at the same time. Coupling protrusions 44 similar to the first coupling protrusions 40 as described above are formed on the side of the first opening 35 of the box body 31. Then, cut-out grooves 46 are formed on the coupling protrusions 44. Coupling grooves 45 are formed on the surface of the second cover 38 to correspond to the coupling protrusions 44. Accordingly, both sides of the coupling piece 63 of the guide wheel 60 can be respectively fitted.

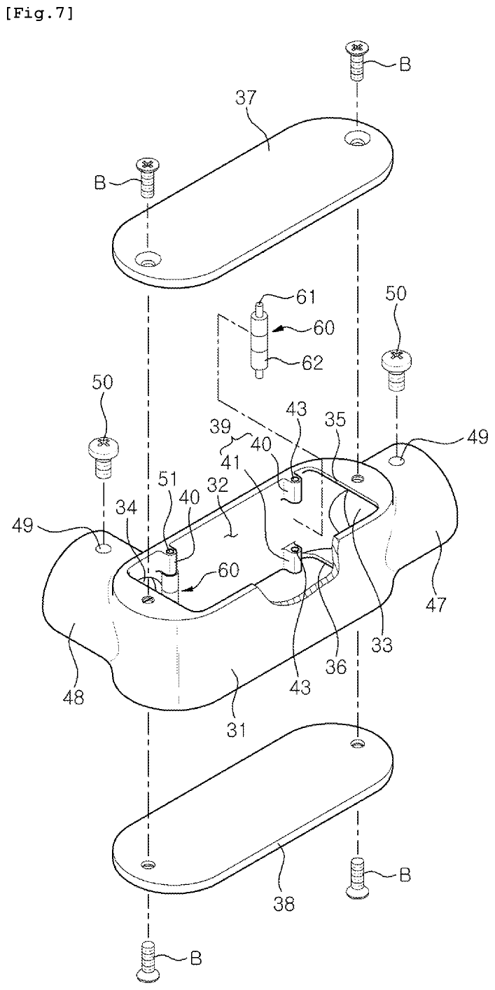

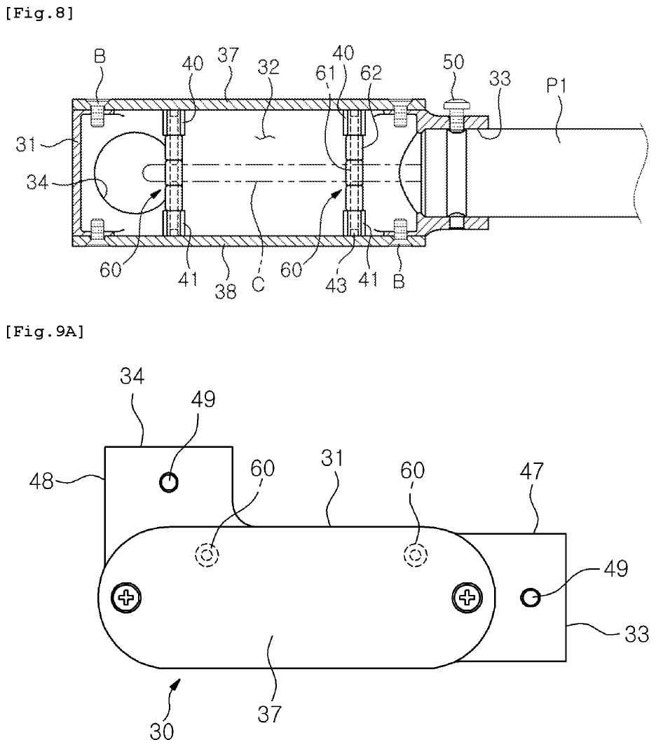

In addition, as shown in FIGS. 7 and 8, as another coupling method of the present invention, unlike the above-mentioned fitting coupling, it may be provided to shaft-couple the guide wheels 60. In this example, shaft holes 43 in the form of holes or grooves penetrating up and down are formed on each of the coupling protrusions 40 and 41. The guide wheels 60 are provided in a state excluding the above-described coupling piece 63. Accordingly, both ends of the wheel shaft 61 may be directly coupled to the shaft holes 43.

Here, in the present invention, when the incision groove 42 or the shaft hole 43 is formed on the coupling protrusions 40 and 41 as described above, since both sides of the box body 31 have an open structure, The first coupling protrusion 40 is primarily processed. Thereafter, the box body 31 may be turned over and the second coupling protrusion 41 may be secondly separately processed. As such, the present invention can give convenience in processing.

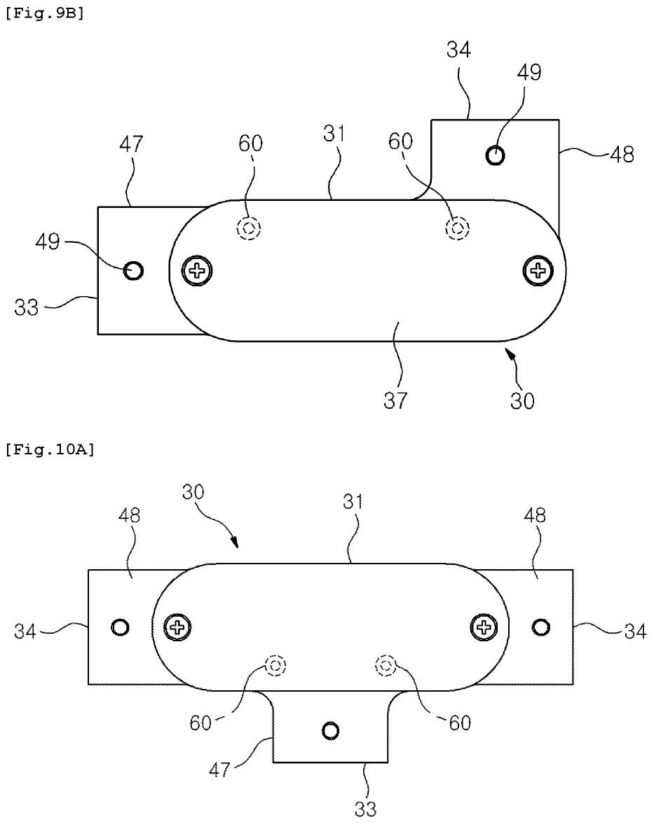

In the present invention as described above, the arrangement of the inlet 33 and the outlet 34 or the shape of the box body 31 may be variously provided, which will be described with reference to FIGS. 9 to 12 as follows.

As shown in FIG. 9A and FIG. 9B, the box body 31 of the present invention may be configured in an L-shape or an inverted L-shape in which the inlet 33 and the outlet 34 are disposed at 90 degrees. Conventionally, when manufacturing such an L-shape or an inverted L-shape, each is separately manufactured. However, since the present invention has a structure in which both sides of the box body 31 are open, it is possible to achieve an L-shape or an inverted L-shape by simply installing the same single product by reversing the installation direction. Accordingly, it is possible to manufacture the box body 31 without directionality.

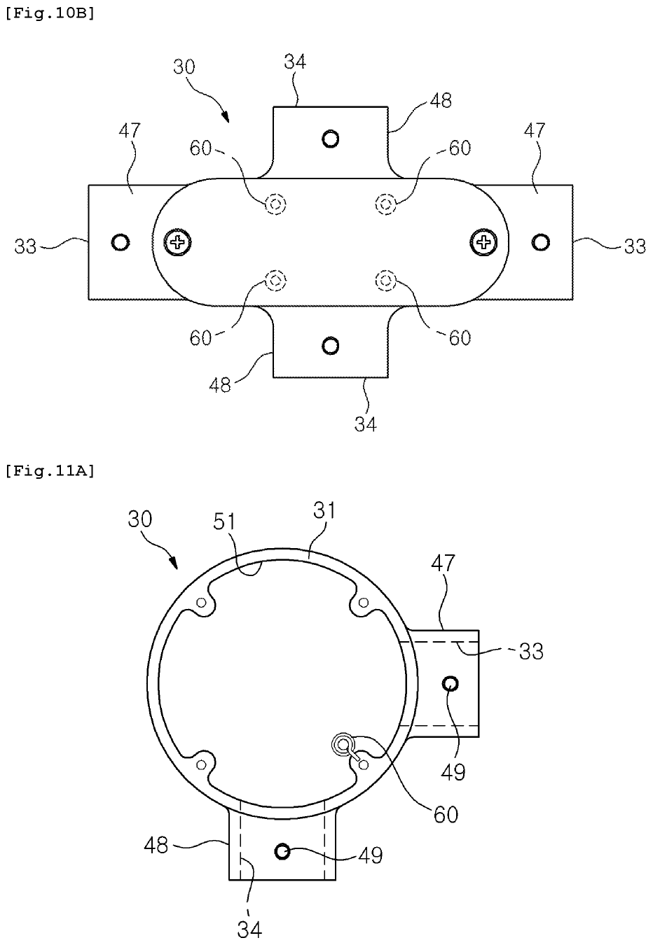

In addition, as shown in FIG. 10A and of FIG. 10B, the box body 31 of the present invention may be configured in a T-shaped or cross-shaped structure that can form a plurality of the number of the inlet 33 or the outlet 34. In this case, it is natural that the number and arrangement of the guide wheels 60 installed in the box body 31 can be properly installed.

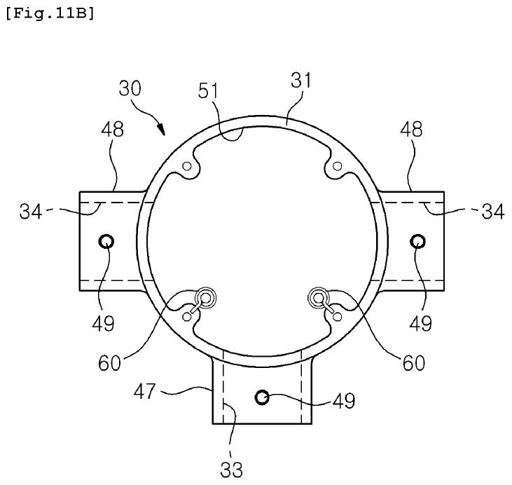

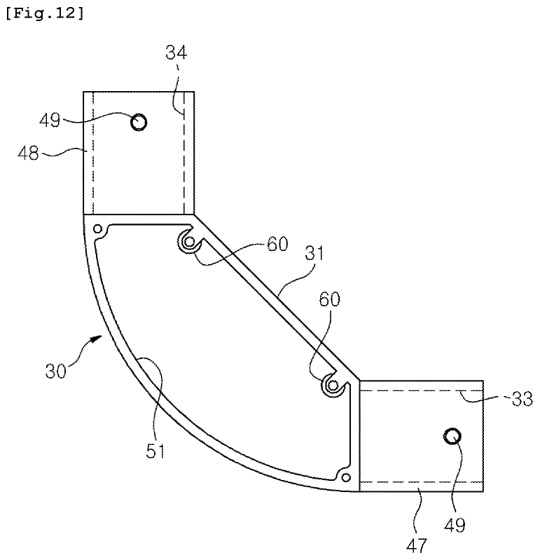

In addition, as shown in FIG. 11A and FIG. 11B, the shape of the box body 31 may be provided in the form of a circular cross-section, wherein the inlet 33 and the outlet 34 may be arranged at 90 degrees or 180 degrees. And as shown in FIG. 12, it may be provided in the form of an elbow in which a curved portion 51 of a certain curvature is formed, extending from the inlet 33 to the outlet 34 on the inner space 32 of the box body 31.

Here, as shown in FIG. 12, the box body 31 is shaped as an elbow shape, and accordingly, a curved portion 51 of a certain curvature is formed on the inner space 32. When the cable C is pushed in from the outside, it is preferable that the curvature is standardized so that the direction can be easily changed to the outlet 34 side. In this case, when the box body 31 is installed, the respective covers 37 and 38 are installed in a sealed state. There is no need to manually pull the cable C with the first cover 37 of the box body 31 open. Only by pushing in the cable C from the outside, the cable C can be automatically turned in a state of direction, which can give convenience in wiring work.

On the other hand, as shown in FIG. 11, In the case of the circular box body 31, a curved portion 51 of a certain curvature is formed on the inner space 32. In the case of the curved portion 51, it is difficult to change the direction of the cable C toward the outlet 34 when the cable C is pushed in from the outside. However, the box body 31 of a circular cross section can be selectively applied according to the installation location or environment.

The present invention described above is not limited by the above-described embodiments and the accompanying drawings, and It will be clear to those who have the knowledge of that it is common in the technical field to which the present invention pertains that various substitutions, modifications and changes are possible within the scope without departing from the technical spirit of the present invention.

1. A double-sided open-type conduit box for wiring electric wires, comprising:
a box body in which an inlet and an outlet, through which a cable C goes in and out, are formed at both sides of an inner space of a predetermined size, and first and second openings and are formed to open one side and the other side of the inner space;
a first cover configured to open and close the opening;
a second cover configured to open and close the opening; and
guide wheels mounted in the inner space and rolled to guide the progress of the cable C; and
wheel coupling portions formed to mount the guide wheels.

2. The double-sided open-type conduit box for wiring electric wires of claim 1, the wheel coupling portions are formed to protrude into the inner space on the box body, comprising first coupling protrusions formed on the side of the first opening and second coupling protrusions formed on the side of the second opening to correspond to the first coupling protrusion.

3. The double-sided open-type conduit box for wiring electric wires of claim 1, wherein the wheel coupling portion includes a coupling protrusion formed on the side of the first opening to protrude into the inner space on the box body, and a coupling groove formed on the surface of the second cover 38 to correspond to the coupling protrusion.

4. The double-sided open-type conduit box for wiring electric wires of claim 2, wherein a guide wheel includes a wheel shaft extending to a predetermined length, and rollers rotatably coupled to the wheel shaft, and wherein shaft holes to which the ends of the wheel shafts are coupled are formed in each coupling protrusion or of the wheel coupling portions.

5. The double-sided open-type conduit box for wiring electric wires of claim 2, wherein a guide wheel includes a wheel shaft extending to a predetermined length, rollers rotatably coupled to the wheel shaft, and a plate-shaped coupling piece extending to one side of the rollers connected to the wheel shaft, and wherein in each coupling protrusions of the wheel coupling portions, a cut-out groove into which the coupling piece is inserted is formed.

6. The double-sided open-type conduit box for wiring electric wires of claim 1, wherein the box body is integrally formed with connector parts to extend the inlet and the outlet, and wherein fastening holes of a certain size is formed on one side of the outer periphery on each of the connector parts, and the tube bodies P1 and P2 connected to the box body are fastened by tightening bolts.

7. The double-sided open-type conduit box for wiring electric wires of claim 1, wherein the box body has a curved portion of a certain curvature extending from the inlet to the outlet on the inner space, or the shape of the box body itself is in the form of an elbow.

8. The double-sided open-type conduit box for wiring electric wires of claim 3, wherein a guide wheel includes a wheel shaft extending to a predetermined length, and rollers rotatably coupled to the wheel shaft, and wherein, shaft holes to which the ends of the wheel shafts are coupled are formed in each coupling protrusion of the wheel coupling portions.

9. The double-sided open-type conduit box for wiring electric wires of claim 3, wherein a guide wheel includes a wheel shaft extending to a predetermined length, rollers rotatably coupled to the wheel shaft, and a plate-shaped coupling piece extending to one side of the rollers connected to the wheel shaft, and wherein in each coupling protrusions of the wheel coupling portions, a cut-out groove into which the coupling piece is inserted is formed.
